(19) United States
(12) Patent Application Publication
(10) Pub. No.: US 2004/0258794 A1
(43) Pub. Date: Dec. 23, 2004

(54) Apparatus for thermally insulating a molding machine nozzle from the mold

(76) Inventors: Kenneth Edward Wood, Macedon, NY (US); Richard Fredrick Van Cuyck, Fairport, NY (US)

Correspondence Address: KENNETH E. WOOD, 1855 MACEDON CENTER ROAD, MACEDON, NY, 14502-9175, US

(21) Appl. No.: 10/464,189

(22) Filed: Jun. 18, 2003

(51) Int. Cl. B29C 45/00

(52) U.S. Cl. 425/567

(57) ABSTRACT

An apparatus for thermally insulating a molding machine nozzle from the mold utilizing a flexible thermal barrier material made of polyimide.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of injection and transfer molding and more specifically to an apparatus for thermally insulating a molding machine nozzle from the mold. This invention applies to a wide range of processes in which a material is transferred from a molding apparatus to a mold, in which the the molding apparatus and the mold are at different temperatures. This invention relates to, but is not limited to, the molding of such materials as polymeric plastics, elastomers, metals, ceramics, and so forth.

Thermal barriers between the nozzle and the mold for molding machines have consisted of such simple materials as corrigated cardboard and molded rigid thermoplastic seals to more complex designs incorporating rigid insulating materials housed in complex nozzle and mold structures, such as an injection molding nozzle having a nozzle tip insulator assembly affixed therein comprised of an inner sleeve and an outer sleeve in the nozzle tip design.

The use of such simple materials as corrugated cardboard as a thermal insulator between a molding machine nozzle and a mold lack the temperature resistance for long term use. Use of such materials results in thermal breakdown of the insulating material over time, which results in highly variable performance and requires frequent replacement. Other more thermally resistant materials require complex designs that are both limited, in terms of design applicability and are expensive to produce. In addition, simple thermal barrier rigid materials do not have the flexibility to adapt to a wide range of nozzle and mold design configurations.

### BRIEF SUMMARY OF THE INVENTION

The primary object of the invention is to provide a flexable thermal barrier between the machine nozzle and mold that eliminates the solidification of the material in the nozzle.

Another object of the invention is to provide a flexable thermal barrier between the machine nozzle and mold that eliminates the need for retracting the nozzle from the mold to allow for thermal recovery, the process of which can result in material leaking from the nozzle.

Another object of the invention is to provide a flexable thermal barrier between the machine nozzle and mold that reduces heat transfer between the machine nozzle and mold that subsequently lowers nozzle temperature requirements and results in faster cycle times.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an apparatus for thermally insulating a molding machine nozzle from the mold, comprising: a flexible thermal barrier material made of polyimide.

### BRIEF DESCRIPTION OF THE DRAWINGS

The drawing constitutes a part of this specification and includes an exemplary embodiment to the invention, which may be embodied in various forms. It is to be understood that in some instances various aspects of the invention may be shown exaggerated or enlarged to facilitate an understanding of the invention.

FIG. 1 is a cross sectional view of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

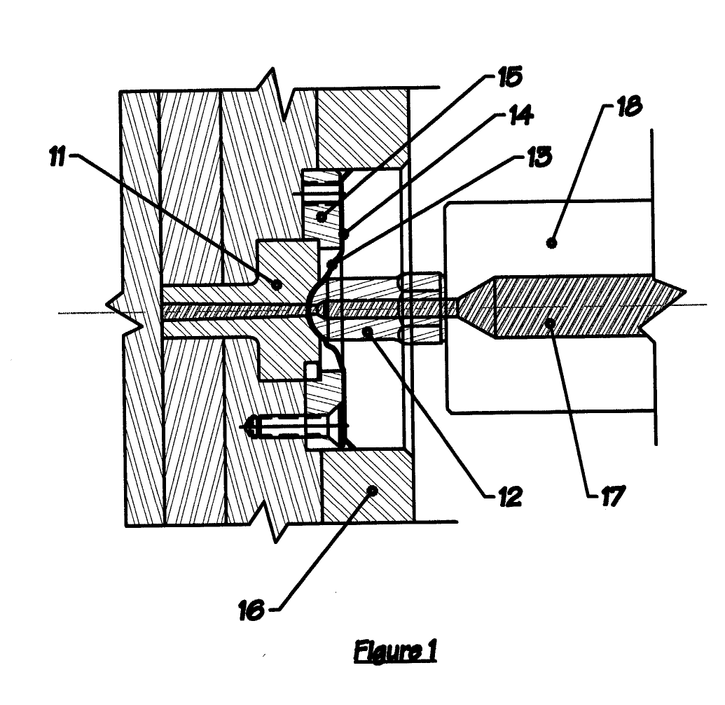

In accordance with the present invention, FIG. 1 shows the flexible thermal barrier material apparatus, comprised of polyimide material, Item 13, between the machine nozzle, Item 12, and mold, Item 11. Item 13 acts as a flexible thermally insulating material, thereby significantly reducing, or eliminating, heat transfer between between Item 12, the machine nozzle and the mold, Item 11.

In the particular device illustrated in FIG. 1, pursuant to the invention, the flexible polyimide material can be held in a carrier, Item 14, made of, but not limited to, such materials as cardboard, plastic, or metal to provide ease of use in handling and insertion of the flexible polyimide material into the machine, which in this illustrated form is described by, but not limited to, a mold locating ring, Item 15, which locates same said mold in the machine platen, Item 16. In addition, FIG. 1 illustrates the material being molded as it flows through its machine and mold flow channels, Item 17, as it flows from the machine barrel Item 18 into the mold, Item 11.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An apparatus for thermally insulating a molding machine nozzle from the mold comprising:
a flexible thermal barrier material made of polyimide.
